(19) United States
(12) Patent Application Publication
(10) Pub. No.: US 2008/0199624 A1
(43) Pub. Date: Aug. 21, 2008

(54) Coating for a sliding silicone seal with a low coefficient of friction and a very low tendency to squeak or chatter

(75) Inventor: George Juris Viksne, Gulf Breeze, FL (US)

Correspondence Address: George Viksne, 1141 Laguna Lane, Gulf Breeze, FL, 32563-3325, US

(73) Assignee: SETi Mold-Ex, Milton, FL (US)

(21) Appl. No.: 11/707,454

(22) Filed: Feb. 16, 2007

(51) Int. Cl. B05D 7/00

(52) U.S. Cl. 427/407.1

(57) ABSTRACT

The present invention relates to a method of reducing or completely eliminating noise generated by a sliding seal. The method comprises of adding an aminosilane or an aminofunctional silicone fluid to a low friction coating composition.

### FIELD OF INVENTON

The invention relates to a system incorporated in or applied to a low friction silicone gasketing system.

### BACKGROUND OF THE INVENTION

1. Field of Invention

The present invention relates to elastomeric gaskets engineered for sliding surfaces such as but not exclusively to automotive windows and sunroofs where the position of the panel is changed frequently and the gasket must maintain a good weather seal. Common problems for existing systems of this type of seal often include chatter or squeaking of the seal. The sound is usually generated while the panel is being moved either deliberately opening or closing the aperture or from slight movement of the pane while driving over a rough road. The tendency to squeak or chatter can be influenced by ambient temperature, humidity, and composition of the paint or clearcoat. This invention greatly reduces the chattering phenomenon without reducing the positive attributes of the coating such as low coefficient of friction and durability.

2. Description of Prior Art

Silicone based low friction coatings are in use for many moving elastomer seal applications. Most of these coatings are formulated products containing a resin/or elastomer binder, and one or more low friction powdered additives such as polytetrafluoroethylene (PTFE) and graphite. Other known additives to the coating which may reduce friction and or noise may include families such as silicone oils and waxes; halogenated oils and waxes; certain metal soaps such as zinc stearate; selected fillers such as plastic or glass micro spheres, talc, graphite, and molybdenum disulfide. In addition, some solutions to the problem are cost-prohibitive in many applications. While the formulation with materials similar to the above mentioned is being developed, key functional factors such as film flexibility, adhesion to substrate, bleed or stain resistance, and durability must be maintained. As the seal is in service, silicone and halocarbon oils, which may contribute to the squeak control, bleed or dissipate because of their mobility. The waxes and soaps, with time, also migrate out of the matrix.

U.S. Pat. No. 6,296,907 discloses a low friction, silicone based coating for gaskets with lateral movement during service. Although this system functionally performs well, there are instances where due to varying painted surface characteristics, squeaking or chattering of the seal/car body interface is present.

### SUMMARY OF THE INVENTION

The objective of this invention is to apply a low friction coating to a finished elastomeric or plastic article which will adhere to the substrate, provide the low friction characteristics, and minimize the tendency of the seal to squeak or chatter. The invention involves the preparation of a low friction coating described in the prior art with the addition of a quantity an amino silane or amino organopolysiloxane copolymer. The amino group may be a primary, secondary or tertiary amine; the amine group may consist of single or multiple amino groups; the amine groups may be linear, branched, cyclic, aromatic, or any combination of the above; the amine group may in the form of a salt of an inorganic or organic acid of any of the above mentioned combinations. The “amino silicone additive” may be incorporated in the coating formulation prior to application on a seal, or applied on an existing coated seal in a separate step. Gaskets treated in this manner exhibit a much lower tendency to squeak or chatter in service and, when incorporated into a matrix, are not subject to dissipation through friction, out-gassing, etc.

### DESCRIPTION OF THE INVENTION

The present invention relates to a gasket coated with a silicone resin based coating with at least one lubricating filler and an aminosilane, aminoorganopolysiloxane and/or aminoorgano, organopolysiloxane copolymer.

The aminoorganosilanes should be alkoxy silanes or contain another reactive group. They can be incorporated in an optimized coating formula familiar to the art where premature hydrolysis of the alkoxy groups does not occur.

The aminoorganopolysiloxanes containing the sequence; O—Si—(C₍₁₋₁₂₎)—N—H, are incorporated in an optimized formula. In the aminoorganopolysiloxane the amino group may contain more than one C—N—H sequence. The aminoorganopolysiloxane should contain between 0.25 and 100 mole percent amino groups. A typical example would be a dimethylpolysiloxane fluid containing 5 mole percent methylaminoprolylsiloxy and 95 mole percent of dimethylpolysiloxy groups at 300 cs viscosity.

The amino silane and/or siloxane may be applied by incorporating into the coating formula with the resin or applied as a separate operation. The amino siloxane should be a liquid or in solution during application. The minimum quantity of silicone applied should be enough to leave a film at least one molecule thick on the gasket area required.

The silicone resins of the present invention are those resins known in the art. Silicone resins are highly cross-linked high molecular weight siloxanes and are available as solid form such as powders and flakes, dispersion in solvent, and liquid form. The monovalent hydrocarbon groups on the siloxane backbone may be from 1 to 18 carbon atoms. The mono-/di-/tri-/tetra-functionality ratio of the siloxane matrix should be such as to give both sufficient flexibility and hardness to the final coating. This ratio may vary depending on the monovalent hydrocarbon species on the siloxane backbone, other ingredients in the coating, and on the specific application.

Tests on complete seals showed that the invention functions through a wide temperature range and has no effect on the durability of the seal.

According to this invention, the silicone coating composition comprises:
A. a silicone resin system
B. at least one lubricating filler not soluble in the coating composition
C. an amino silane or a polysiloxane
D. a solvent (optional)

The components of the coating may be combined in any manner that assures the ingredients are uniformly dispersed. The invention can be formulated as a solution or emulsion.

### EXAMPLES

1a. A low friction coating was prepared according to Claim 2 using 0.5% (based on solids) aminopropyltriethoxysilane.

1b. A similar coating to 1a was prepared with the aminopropyltriethoxysilane omitted.

Each of the 2 samples was single coated onto a 2-meter length of uncoated silicone sunroof seal. The two seals were oven cured 1 hour at 177° C.

10 cm sections of cured 1a and 1b seals were tested by placing the bulb of the seal against a painted test panel with sufficient pressure to deflect the bulb approximately 50%. While deflected, the test gasket was drawn slowly across the surface of the rest panel starting and stopping frequently. Further testing involved moving the test strip back and forth approximately 1 cm at various speeds while the bulb is deflected. If the seal section chattered or squeaked at any of the above conditions the result is noted. This procedure was repeated using several specified test panels by several individuals. The following results were noted.

1a and 1b were tested to the above procedure against a Honda test panel coated with Dupont RK-8034/clearcoat HCX-300 at 25° C. and 50% RH. 1b exhibited chatter at starting at approximately 265 cm/minute at 50% bulb deflection. 1a did not chatter or squeak under similar conditions.

1a and 1b were tested to the above procedure against a Honda test panel coated with PPG HDCT4031AE at 25° C. and 50 % RH. 1b exhibited a low pitch squeak at approximately 70% bulb deflection at approximately 10 cm per minute. 1a did not squeak under similar condition.

2a low friction coating was prepared according to Claim 2 using 2% of a 130 centistoke Dimethylpolysiloxane with 4% AminopropylaminoethylMethylsiloxy groups.

2b a similar coating to 2a was prepared without the Dimethylpolysiloxane with 4% AminopropylaminoethylMethylsiloxy groups.

2a and 2b were tested at 25° C. and 50% RH to the above procedure against a test panel coated with BASF B517P. 2b exhibited chatter at starting between 50 and 80% deflection. B1 did not chatter or squeak under any of the above test conditions.

Note that all the preceding tests were replicated using at least four observers. Subsequently, in order to validate the laboratory results, a component utilizing the present teaching was fabricated and supplied to an end-use company which, after testing, verified the absence of squeak or chatter in a practical, real-world application.

What is claimed is:

1. A method for reducing the tendency to squeak or chatter in a low friction gasket subject to lateral forces, comprising;
A. applying to said gasket a low friction coating composition comprising,
i a silicone containing resin system
ii at least one lubricating filler not soluble in the coating composition
iii optionally a solvent
iv an organosilane or polysiloxane containing at least one amino group
B. curing the silicone coating composition.
C. applying the aminosilane or aminopolysiloxane to a gasket, which has previously been coated with a low friction coating.

2. A method as claimed in claim 1, where the silicone resin is an OH functional methylpolysiloxane and the amino silane is aminopropyltrimethoxysilane.

3. A method as claimed in claim 2, where the aminopolysiloxane is aminoethylaminopropylMethylsiloxane-Dimethylsiloxane Copolymer.

4. A method as claimed in claim 2, where the aminopolysiloxane is diaminopropylEthoxysiloxane-Dimethylsiloxane-phenylmethylsiloxane Copolymer.
